(19) United States
(12) Patent Application Publication
(10) Pub. No.: US 2016/0098787 A1
(43) Pub. Date: Apr. 7, 2016

(54) Method and System for an Electronic Auction

(71) Applicant: EPIC TECH, LLC, Lavonia, GA (US)

(72) Inventor: Timothy O. Caldwell, Piedmont, SC (US)

(21) Appl. No.: 14/877,737

(22) Filed: Oct. 7, 2015

Related U.S. Application Data
(60) Provisional application No. 62/060,610, filed on Oct. 7, 2014.

(51) Int. Cl. G06Q 30/08; G06Q 30/06; G06Q 30/02

(52) U.S. Cl. CPC G06Q 30/08; G06Q 30/0212; G06Q 30/0643

(57) ABSTRACT

The invention comprises a method and system which will simultaneously display a plurality of electronic bidding fee auctions. Users may simultaneously place at least one bid on each of the displayed electronic auctions using a single action, such as a single mouse click, keyboard stroke, or the pressing of a touch screen monitor. At least one bid is then placed in each auction. Each of the displayed auctions may end at different times and, as they end and a winner is notified, each ended auction is immediately replaced by another auction such that continuous bidding is not interrupted.

This application is a non-provisional of and claims the benefit of U.S. Provisional Patent Application No. 62/060,610, filed on Oct. 7, 2014 by Timothy O. Caldwell and entitled METHOD AND SYSTEM FOR A HIGH SPEED ELECTRONIC AUCTION, wherein the entire disclosure of the foregoing is hereby incorporated by reference in its entirety as if set forth verbatim herein.

### BACKGROUND

Online auctions are a method of selling products to consumers. A consumer can typically purchase an item for a discount by participating in and winning the online electronic auction. The present system and methods are directed to electronic auctions.

### SUMMARY OF THE INVENTION

In an embodiment, the invention is directed to a computer-implemented method of providing an electronic auction. In an embodiment, the electronic auction is promoted through an electronic sweepstakes system (also referred to herein as an electronic game promotion).

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 shows a diagrammatic representation of an exemplary software system;

FIG. 2 shows a flow diagram of an exemplary software system; and

FIG. 3 shows an exemplary end user auction display.

### DESCRIPTION OF SOME EMBODIMENTS

Reference will now be made in detail to embodiments of the present systems and methods, one or more examples of which are illustrated in the accompanying drawings. Each example is provided by way of explanation, not limitation of the present system. In fact, it will be apparent to those skilled in the art that modifications and variations can be made to the present system and methods without departing from the scope or spirit thereof. For instance, features illustrated or described as part of one embodiment may be used in another embodiment to yield a still further embodiment. Thus, the present system and methods cover such modifications and variations as come within the scope of the appended claims and their equivalents.

### Overview

The present systems and methods are directed generally to an electronic auction. In an embodiment, the electronic auction is promoted through an electronic game promotion or sweepstakes. Generally speaking, the software system provides a server-based and/or Internet-based auction. The system may also utilize a server-based and/or Internet-based promotional sweepstakes.

In various embodiments, the system may be utilized in a brick and mortar location. In these embodiment, the brick and mortar business sells “bids” that may be used for bidding on items for sale in the electronic auctions. The bids may be sold individually or in groups or packs. For example, bids may be sold in a pack of 100 bids. In some embodiments, bids may be sold in packages that have any known quantity of electronic bids. In other embodiments, the more bids the user purchases at a single time the lower the cost per bid. In various embodiments, bids purchased from the brick and mortar business, rather than from an Internet-based home computer, may be less expensive. For example, a bid pack purchased from the brick and mortar store may be $0.45 rather than $0.60 per bid. A bid purchase may be made by credit card, debit card, check or cash. In various embodiments, the purchase may be made by bank wire or any other suitable payment method. Note that throughout this application, the electronic product used to participate in an auction is referred to as a “bid,” but, as used herein, this term includes any electronic product known in the art to be useful to designate participation in an electronic auction.

In a brick and mortar business, the inventive system may comprise software components for a management terminal, a cashier terminal, and/or an end user terminal. Any of the management terminal, cashier terminal, and/or end user terminal may be a kiosk, computer, or other terminal device. The management terminal software component may be used by a manager to run reports regarding cashier shifts, bids purchased, auctions won, products purchased, and the like, as well as manage the day-to-day business operations. In an embodiment, the cashier terminal aspect of the software may be utilized by a cashier to allow creation of an electronic auction account for each new user, account lookup for returning users, receipt of money from users, provision of free game pieces upon request pursuant to the alternative method of entry into the game promotion, and/or purchases of bids by end users. The cashier terminal software may include functionality to allow for printing of receipts for end users which summarizes their activities and/or provides them with a unique identification number. The end user terminal software component may be used by an end user to access the auction software, as will be more fully described herein. In an alternative embodiment, the customer may exit the brick and mortar location and access the electronic auction and/or sweepstakes from any computer connected to the Internet.

In other embodiments, the system comprises a purchase of bids by a customer directly through a user-operated terminal, such as a kiosk, computer, or other terminal (no human cashier necessary) located in a brick and mortar location. In these embodiments, the software may still comprise software components for a management terminal, a cashier terminal, and/or an end user terminal, but the cashier terminal software may exist on the user-operated terminal. In fact, in any of these embodiments, software components for the management terminal, the cashier terminal, and/or the end user terminal may exist on separate terminals, may overlaps on terminals, or may all exist on the same terminal. In the kiosk embodiments, a customer may approach the kiosk, computer, or terminal (hereinafter the “terminal”), input a method of payment, and purchase the desired number of bids. In various embodiments, the customer may then use the same terminal, a separate computer or an end user terminal located in a brick and mortar location to access the electronic auction and/or sweepstakes. In an alternative embodiment, the customer may exit the brick and mortar location and access the electronic auction and/or sweepstakes from any computer connected to the Internet.

In alternate embodiments, access to the system, including purchase of bids, use of the electronic auction, and use of the electronic sweepstakes, can be implemented from any computer connected to the Internet and not related to a brick and mortar store. The system may be available over the Internet, or other Network, and all data may be stored on one or more physical servers and/or on a cloud server. The purchase of bids may be accomplished via credit card, debit card, PayPal® account, or similar service.

In one embodiment, the customer purchases bids at an end user terminal, whether that is a home computer connected to the Internet or an end user terminal at a brick and mortar business location. In this embodiment, the customer may be required to create an auction account. If the user is a return user, he may need to use log-in credentials to access the system. Log-in credentials can comprise anything known in the art such as a username and password, a unique PIN, or the like. The user may be then prompted to view the auctions that are available and/or to purchase bids. Once bids have been purchased, the user may participate in one or more auctions.

In various embodiments, the electronic auction may be configured to receive bids from one or more users. In some embodiments, the auction is won by the person that places the highest bid or the last bid before the auction ends. In some embodiments, winning the auction entitles the winner to the product auctioned without further payment. In other embodiments, winning the auction requires payment of a cost associated with the auction win. In still other embodiments, all losing bidders may be able to purchase the auctioned item for a predetermined price. In some of these embodiments, the number of bids expended during the auction may be used to offset the final price that must be paid by the losing bidders or may be returned to the losing bidders.

Once the customer purchases bids, the system may be configured to automatically allocate a predetermined number of sweepstakes entries (also known herein as game pieces or promotional game pieces) to the user's account. In another embodiment, once the customer uses bids, the system may be configured to automatically allocate a predetermined number of sweepstakes entries to the user's account. The number of sweepstakes entries may be fixed, may be proportional to the number of bids purchased or used, or may be based on any other relevant factors. In various embodiments, the customer may request that one or more sweepstakes entries be revealed before, during, or after participating in an electronic auction. The customer may request a reveal of at least one entry by selecting a button or link on a computer terminal that is being used to access the electronic auction. In various embodiments, the user may need to log in to a separate system to reveal the results of the electronic sweepstakes entries.

### Exemplary Technical Platforms

As will be appreciated by one skilled in the relevant field, the present invention may be, for example, embodied as a computer system, a method, or a computer program product. Furthermore, particular embodiments may take the form of a computer program product stored on a computer-readable storage medium having computer-readable instructions (e.g., software) embodied in the storage medium. Various embodiments include web-implemented computer software. Any suitable computer-readable storage medium may be utilized including, for example, hard disks, compact disks, DVDs, optical storage devices, and/or magnetic storage devices.

Various embodiments are described below. It should be understood that, in some embodiments, each element of the invention can be implemented by a computer executing computer program instructions. These computer program instructions may be loaded onto a general purpose computer, a special purpose computer, smart mobile device, a gaming server, a gaming machine, or other programmable data processing apparatus to produce a machine. As such, the instructions may execute on any computer, which as used herein may include any general purpose computer, special purpose computer, smart mobile device, or other programmable data processing apparatus create means for implementing the functions described herein. The program code may execute entirely on the user's computer, partly on the user's computer, as a stand-alone software package, partly on the user's computer and partly on a remote computer, or entirely on the remote computer or server. In embodiments utilizing a remote computer, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the functions described herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein.

### Exemplary System

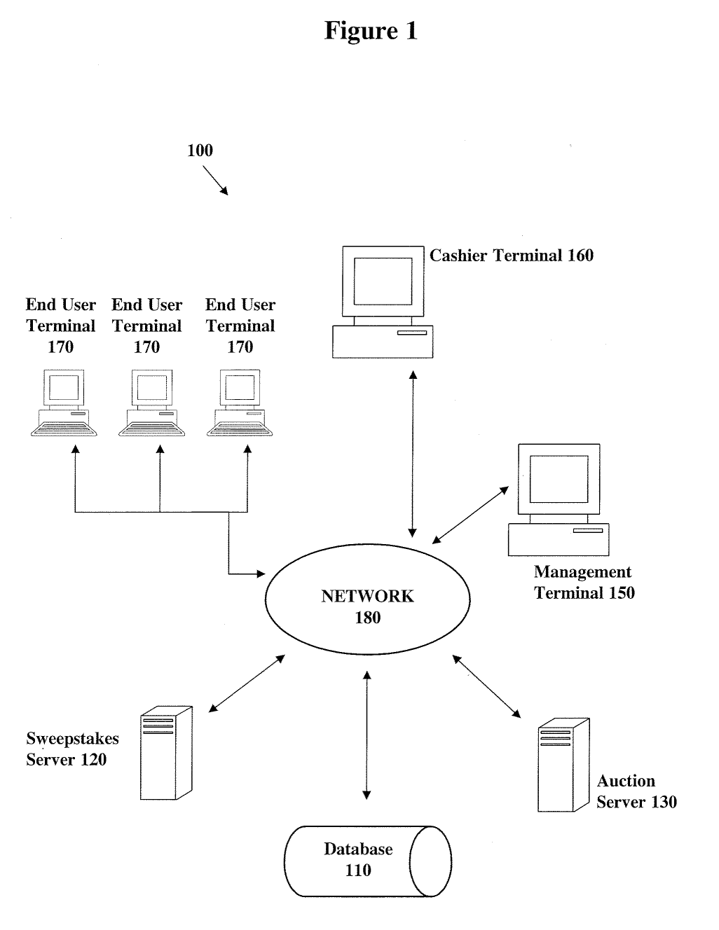

By way of example, and with reference to FIG. 1, the inventive system 100 may comprise a database 110, at least one auction server 130, at least one sweepstakes server 120, at least one management terminal 150, at least one cashier terminal (also known as a point-of-sale terminal or POS terminal) 160, one or more end user terminals 170, or any combination thereof. Those skilled in the art with reference to this disclosure should appreciate that other configurations may be used to accomplish the methods described herein without departing from the scope of the present invention. For example, in various embodiments, sweepstakes server 120 may be configured to also provide the functionality provided by auction server 130. Alternatively, the cashier terminal 160 and the end user terminals 170 may comprise the same device.

It should be understood that each of the computing devices, including the sweepstakes server 120, the auction server 130, the management terminal 150, the POS terminal 160, and the one or more end user terminals 170 may each have a computer hardware processor, input and output devices (for example, a computer monitor, a keyboard, selection buttons, and/or mouse) and at least one storage device (for example, memory, hard drives, etc.). These devices may also have network connection cards to connect to the network. At least some of these devices may also include a computer readable medium, which is further described herein.

The sweepstakes server 120 and auction server 130 may be configured to communicate data to and from various devices in the system and to perform one or more method steps, as detailed below. The database 110 may contain various types of data and computer instructions for performing at least some of the steps presented herein. It should be understood that the network 180 may be comprised of multiple auction servers 130 and/or sweepstakes servers 120 and multiple databases 110, whether located locally and networked through a LAN or remotely through a WAN or an Intranet connection. The end user terminals 170 may be linked together via a network. Each end user terminal 170 may be a standard standalone end user terminal, a personal computer (PC) or other computing device.

The POS device 160 and/or the end user terminals 170 may allow a user to buy bids, buy products won in an auction, buy products not won in an auction, provide sweepstakes entries, manage user accounts, and the like. In various embodiments, the customer may use the POS device 160 to directly purchase bids to use in an online auction on the end user terminals. In some embodiments, a user account card may be issued by the POS device 160, which contains an electronic account detailing purchased bids, sweepstakes entries, and user account information. The user account card may be used to participate in electronic auctions, to place bids on items that the customer wishes to purchase, and/or to access electronic sweepstakes promotions.

If a user enters a brick and mortar location, a POS device 160 (through a cashier or directly) may provide the user with a receipt containing a code (such as a 16-digit hexadecimal code), a PIN, or a username/password that the user may then use to access his/her account on an end user terminal 170. In an online embodiment, the user may access the inventive system through a browser interface that may provide a similar code to the user after account creation. This code may provide access to the auction software/website and/or specifically to the customer's account on the software/website. In various embodiments, the user may be required to input certain biographical information, such as name, phone number, username, password, date of birth, and/or email address when creating an account using any of the methods described herein. Such information may be stored in the database 110.

In various embodiments, the system may allow a user to deposit currency into an electronic wallet and then purchase bids on an as-needed basis. For example, in a brick and mortar business, the user may deposit money onto an electronic account at the cashier terminal 160, but has not yet purchased any bids until the user accesses the software at the end user terminal 170. In yet other embodiments, the system allows a customer to purchase electronic currency and later use that electronic currency to purchase bids. In still other embodiments, no electronic wallet is needed and the user may directly purchase bids (or other products) using a credit or debit card (or other payment method) directly, without inputting funds into an electronic wallet. In still other embodiments, a bid is purchased and used at the same time (i.e. bids are not purchased in advance and then used later, instead both purchase and use of a bid occur simultaneously).

The management terminal 150 may be a device that is operatively connected with the POS terminal 160, end user terminals 170, sweepstakes server 120 and/or auction server 130 to run cashier reports, calculate revenues and costs, track purchases of bids and products, and/or review auction and/or game promotion data. Other managerial or supervisory operations may also be performed using the management terminal 150.

The auction server 130 may control one or more operations of the online auction of items, such as creating online auctions, calculating reserve prices of online auctions, displaying the item(s) being auctioned, allowing purchase of bids, receiving bids, tracking purchased/used bids, tracking auction progress, initiating the start and end of an auction, tracking the winner of the auction, permitting purchase of a product won in an auction or otherwise, and/or any other operations as discussed herein. In some embodiments, the auction server is part of the sweepstakes server such that one server performs all or part of the operations of the auction server and the sweepstakes server.

The sweepstakes server 120 may control one or more operations of the electronic sweepstakes, such as creating finite sweepstakes pools, pulling sweepstakes tickets from the pools, tracking distribution of sweepstakes tickets, displaying graphics in connection with sweepstakes tickets, calculating amount won through sweepstakes prizes, and/or any other operations as discussed herein.

One or more of the devices illustrated in FIG. 1 may be connected to network 180 as previously mentioned. In one embodiment, all devices in FIG. 1 are connected to the network 180 and communicate with each other over the network 180. It should be noted that the network 180 in FIG. 1 need not be a single network (such as only the internet) and may be multiple networks (whether connected to each other or not). In another embodiment, the network may be a LAN and a WAN (e.g., the Internet) such that one or more devices (for example, sweepstakes server 120, auction server 130, management terminal 150 and database 110) are connected together via the LAN, and the LAN is connected to the WAN which in turn is connected to other devices (for example, end user terminals 170). The terms “linked together” or “connected together” refers to devices having a common network connection via a network (either directly on a network or indirectly through multiple networks), such as one or more devices on the same LAN, WAN or some network combination thereof.

It should be understood that FIG. 1 is an exemplary embodiment of the present system and various other configurations are within the scope of the present system. For example, each end user terminal 170 may be located in a user's home. As another example, management terminal 150, point of sale terminal 160, end user terminals 170, and sweepstakes server 120 may all be located in a brick and mortar business location and auction terminal 130 may be located in still another location, where all of these system components are operatively coupled by a network such as the Internet. Additionally, it should be understood that additional devices may be included in the system shown in FIG. 1 and some devices shown in FIG. 1 may be omitted from a particular inventive system, such as, by way of example, the point of sale terminal. In other embodiments, certain devices may perform the operation of other devices shown in the figure.

For purposes of this disclosure, reference to a server or processor, shall be interpreted to include: a single server, a single processor; multiple servers; multiple processors; or any combination of servers and processors. In particular embodiments of the invention, any of the end user terminal 170, the cashier terminal 160, the management terminal 150, the auction server 130, and the sweepstakes server 120 may be a computer. The computer may be connected (e.g., networked) to other computers by a LAN, an intranet, an extranet, and/or the Internet. The computer may operate in the capacity of a server or a client computer in a client-server network environment, or as a peer computer in a peer-to-peer (or distributed) network environment. The computer may be a (PC 140, a tablet PC, a handheld device, a set-top box (STB), a Personal Digital Assistant (PDA), a web appliance, a server 120, 130, or any computer capable of executing a set of instructions (sequential or otherwise) that specify actions to be taken by that computer. Further, the term “computer” may also include any collection of computers that individually or jointly execute a set (or multiple sets) of instructions to perform any one or more of the methodologies discussed herein.

In some embodiments, the computer architecture may include a processor, a main memory (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), and a data storage device, which communicate with each other via a bus.

The processor may be one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, a processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), a network processor, or the like. The processor may be configured to execute processing logic for performing various operations and steps discussed herein.

The computer architecture may further include a network interface device. The computer architecture also may include a video display (e.g., a liquid crystal display (LCD) or a cathode ray tube (CRT)), an alphanumeric input device (e.g., a keyboard), a cursor control device (e.g., a mouse), and a signal generation device (e.g., a speaker).

The data storage device may include a machine accessible storage medium (also known as a non-transitory computer-accessible storage medium, a non-transitory computer-readable storage medium, or a non-transitory computer-readable medium) on which is stored one or more sets of instructions embodying any one or more of the methodologies or functions described herein. The online auction and sweepstakes modules may also reside, completely or at least partially, within the main memory and/or within processing device during execution thereof by a computer. The main memory and processing device also constitute computer-accessible storage media. Instructions may further be transmitted or received over a network via a network interface device.

While the machine-accessible storage medium may be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical, and magnetic media.

### Auction Module

The auction module that resides on auction server 130 may provide various auction functionalities as discussed herein. In various embodiments, the user may access the online auction site through end user terminal 170. In accessing the online auction site, the user may be presented with a welcome screen and asked to enter a code, username and password, or other identifying data. Once entered and confirmed, the system may permit the user to create or view his auction account. The user's auction account may contain information about the user, including, but not limited to, various biographical data, payment data, historical data, and number of bids available for use. The system may display an option for the user to view auctions in progress. If the user elects to view the auctions in progress, the user may view the products that are currently being auctioned and/or available for outright purchase at their retail price. There may be one product available for auction or there may be many products available for auction. The products may be various consumer goods, such as cameras, phones, laptops, sports equipment, etc. In various embodiments, the products may be sporting event tickets, vacation packages, gift cards, bid packs, or any other product that may be sold through an online auction. Each auction may include photographs, product descriptions, product images, retail value, purchase price, or any other relevant information that may be displayed to the user to identify the product being auctioned.

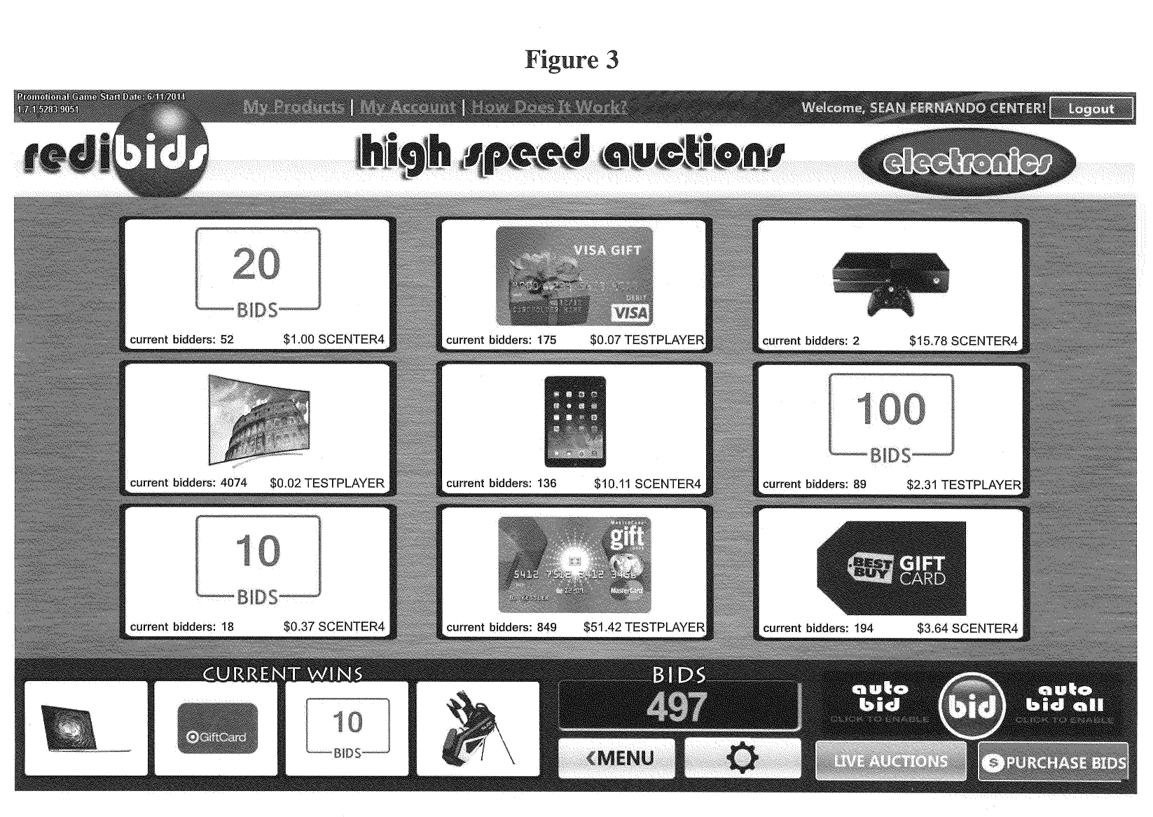

In an embodiment, illustrated in FIG. 3, a bidder may be provided the option of entering one or more auction rooms. As used herein, an auction room is a virtual room in which a plurality of auctions is simultaneously occurring. One exemplary auction room is shown in FIG. 3. Each auction room may be comprised of a plurality of auction items, which are shown in a grid in FIG. 3. The auction items in each room may be entirely, or partially, different. In one embodiment, the rooms may contain auction items of varying value. For example, some rooms would contain products valued near $25 (twenty five dollars) and other rooms might contain products valued near $100 (one hundred dollars). In another embodiment, auction rooms may contain auction products of differing values. In an embodiment, the various auction rooms have themes and/or color schemes that are correlated to the auctions themselves. For example, a sport-themed auction room may be available, wherein all of the auction items are sports related. Similarly, there may be a gardening-themed auction room wherein all of the auction items are gardening related. There may be a gift card auction room, wherein only gift cards are available. In some embodiments, the auction rooms contain auctions that have nothing in common. For example, the room may contain auctions of varying product value and themes.

An auction room may have any number of auction items available. For example, if an auction room is depicted as a grid, the grid could contain 9 auctions (a 3×3 grid), 16 auctions (a 4×4 grid) or any other combination of auctions. The grid need not have a symmetrical appearance or any particular format. In some embodiments, an auction room will have more than one auction at any given time. In the embodiment shown in FIG. 3, the grid contains 9 auctions, 3 of which are gift cards, and 3 of which are bid packs, 1 of which is a video game console (depicted as an Xbox®), 1 of which is a flat screen television, and one of which is an electronic tablet (depicted as an iPad®). The illustrative auction room shown in FIG. 3 is an electronics auction room, as all of the products are electronic in nature. In an embodiment, the bidder can scroll through and select or change individual auction items within an auction room upon which to bid. A bidder may even be able to change all auction items within a room. In another embodiment, the bidder must choose from pre-created auction grids.

In an embodiment, the system may limit the number of individual bidders that may participate in any particular auction room at a given point in time. For example, the maximum number of bidders in an auction room may be 50 bidders, 100 bidders, or any number of bidders. The maximum number of bidders may be variable and/or may be calculated based upon how quickly auctions are ending. In an embodiment, the auctions will end quickly. The maximum number of bidders permitted in a room may be limited so that each auction ends after approximately 15 seconds, 20 seconds, 25 seconds, 30 seconds, 35 seconds or any other time frame. In an embodiment, the number of bidders is limited such that each auctions ends in less than 5 minutes. In another embodiment, the number of bidders is limited such that each auctions ends in less than 1 minute. In an embodiment, the number of bidders is limited based on live or historical user bidding pace, such as, for example, using predictive analysis to calculate the approximate end time of a given auction based on a potential or actual number of bidders.

In an embodiment, the system may limit the entry of bidders into an auction room based upon skill level or number of previous wins. In this embodiment, there may be, for example, beginner auctions and expert auctions.

The auction display may include features such as a graphical or listing of previous auction products that the user has won, a listing of the number of bids available or remaining, a button used to bid on auctions, “Autobid” buttons, buttons that allow the user the view other auctions, and/or buttons used to purchase more bids. Any graphical depiction of buttons may be utilized.

To participate in an auction, the bidder will to press the “bid” button or any button that is an equivalent thereof. When the “bid” button is pressed, one bid will be placed in each auction that is available in the auction room. Thus, in the embodiment depicted in FIG. 3, one bid will be placed in each of the nine auctions, for a total of nine used bids per depressing of the “bid” button.

The auctions may end based upon predetermined criteria once satisfied. In one embodiment, each individual auction within a grid or room will end when a predetermined number of bids have been received in that auction. The last bidder to have placed a bid in that auction will win the auction. The various auctions within a grid or room may end at differing times. For example, the grid in FIG. 3 contains an auction for a BestBuy gift card and an auction for an iPad. The gift card auction may end after 53 bids have been received, but the iPad auction may not end until 827 bids have been received. When any individual auction within an auction room ends, the grid space for that auction item may be filled with another similar item. For example, if the BestBuy gift card auction in FIG. 3 ends after 53 bids, the grid space may be automatically refilled with a DVD player. As such, the grid or room continues to be active and the auctions within that room are periodically changed as one auction ends and another begins.

In some embodiments, a bidder can only be in one auction room at any given time. In another embodiment, a bidder may be able to participate in multiple auction rooms at any given time. In some embodiments, a bidder may be able to toggle back and forth between auction rooms.

The cost of the bids may correspond to the number of auctions in a particular room. For example, if the auction room contains 9 auctions, the bids may cost $0.10 each and may be sold in packs of 9 (for a total of $0.90). Thus, each time a bidder presses the “bid” button, he will place 9 bids valued at $0.10 each or, alternatively, will place one bid, valued at $0.90, across all 9 auctions. The cost of the bids and the number of auctions in any auction room can be varied. In an embodiment, however, the bidder cannot individually bid on the auctions within an auction room. The bidder must place all bids simultaneously using the “bid” button.

In some embodiments, the system provides an automatic bidding feature that, if selected, automatically bids for the user using any number of methods. For example, the system may autobid every certain number of seconds, or it may autobid if another bidder outbids the bidder in the auction room. In some embodiments, a user may be able to program the Autobid feature, specifying the timing that it will place bids or may be able to select from one or more default Autobid options. FIG. 3 illustrates an example of how the autobid feature may be displayed.

In some embodiments, the individual auction items within a room may be selected by the user. In a particular embodiment, auction items within a room are selected by the user based upon a points system. For example, each bidder may be allocated 100 points to be used to select auction items of differing point values. In an embodiment, 25 points may be used to select a blender, 5 points may be used to select a can opener, and the remaining 70 points may be used to select 7 gift cards valued at $10 each. If any of the auctions is won during the bidder's participation period, that auction item can be replaced with any item having the same point value. In some embodiments, a user may freely choose any auction items, optionally to a predetermined minimum and maximum number of items. In some embodiments, the number or costs of bids submitted in such user-selected auction rooms may vary based upon the selected items.

With regard to the user interface, the system may provide a designated area in the user interface that displays the real-time status of the one or more auction rooms selected by the user. This may include a designation of the current number of bidders participating in the auction, the current auction price for the item, previous prices at which auctions for similar products have ended, and/or other relevant data. The auctions status may also be delayed and not necessarily shown in real-time depending on the embodiment of the system.

In various embodiments, the auction may be local and server-based. The products being bid upon may be accessed only by users in a particular brick and mortar location where the relevant auction server is located or, in another embodiment, in a particular city, county, or state where the relevant auction server is located. In another embodiment, however, the same auctions may be accessed by any customer across various states or nationwide. In this embodiment, the inventive system and data may be housed in a centralized server and/or cloud server.

In some embodiments, the bidding may be conducted via a reserve price auction or a minimum bid auction. In this type of auction, a reserve price may be hidden to bidders. In some embodiments, there may be no reserve price at which the auction ends, but a specified number of bids which determines the end of the auction. In this embodiment, the auction ends when the reserve price or number of bids is met. The last bidder to place a bid wins the auction.

In an embodiment, the end point of the auction is determined by an algorithm such that some auctions for a particular product end at a lower number of bids and some auction for that same product end at a higher number of bids. This algorithmic method of determining the end point of the auction allows auctions for the same product to end at different points, but still ensures overall profitability for the auction company.

In other embodiments, a countdown timer is used to indicate the auction end, but if a bidder places a bid during the pendency of the countdown timer, the countdown timer may, in some embodiments, reset. In still another embodiment, the auction ends at a selected time, which may be hidden from the user, and the last bidder wins the auction. In a particular embodiment, there is a maximum number of bids that can be accepted before the auction ends. In still other embodiments, the reserve price model is utilized, but when the reserve price or number of bids has been met, the auction enters a “countdown mode,” in which the last bidder to bid, amongst the eligible bidders, wins the auction.

In an embodiment, when a predetermined number of bids have been received, the system displays a countdown timer to all eligible users. Eligibility may be based upon a variety of factors in various embodiments. For example, the eligibility requirement for the countdown timer aspect of the auction may be that the user has placed a bid within a set time frame. This timeframe could be within 30 seconds, 60 seconds or any number of seconds of when the auction reserve number of bids was met. Likewise, the eligibility requirement could be that only the users that placed a minimum number of bids in the auction are eligible for the countdown mode. In another embodiment, only a set number of the most recent bidders will be eligible for the countdown mode. For example, the last 20 bidders before the reserve was met are eligible for the countdown mode.

In an embodiment, the auction has an eligibility indicator. In this embodiment, if the user bids within a certain timeframe, within 60 seconds for example, they maintain eligibility. There may be a visual display of the user's eligibility shown to each user. For example, an eligibility timer may be shown to the user, such that when the eligibility timer runs out, the user is aware that he is no longer eligible to participate in the final countdown aspect of the auction. The user's eligibility may be indicated with symbols or colors. For example, the user's eligibility may be indicated as a color change from green (eligible), to yellow (close to ineligible), to red (ineligible). Any visual indicator that notifies the user of eligibility could be used in this embodiment.

In various embodiments, when the auction ends any bidder that did not win the auction may have the option to purchase the product he was bidding upon, or optionally, any product offered for auction, at its listed retail price. In a particular embodiment, the bids that were used in bidding for the product may be converted to currency and be debited against the price of the retail product. For example, if each bid costs $0.10 and a user bids 10 times on a $5.00 gift card, but loses the auction, he may purchase the $5.00 gift card for $4.00 (retail value−cost of bids used in unsuccessful auction). Thus, the monetary value of the bids is maintained. Other embodiments include the ability to debit a portion of the cost of bids used in unsuccessful auctions. In an embodiment, the losing bidder may purchase the item at retail cost and the bids used in that auction may be returned to the bidder. In an embodiment, only bids actually purchased can be redeemed in this manner. Any combination of these options may be utilized in the present invention. In various embodiments, the system may be configured to not allow the user to debit bids awarded free of charge against the retail cost of a product.

In an embodiment, if the user fails to use all of his bids during a particular session, those bids will be stored in his user account until he returns to the store/website. The user may utilize those bids at a later date.

### Exemplary Auction Displays

With reference to the drawings, FIG. 3 illustrates an embodiment of the auction. The nine (9) auction products are shown in a grid pattern in the center of the screen. One or more auctions may be bids, consumer products, and/or gift cards. At the bottom left of the screen, a display indicates the auctions that the user has already won (“current wins”). At the bottom right of the screen, a “bid” button and various autobid buttons are displayed. In addition, a button that allows the user to purchase more bids and a button that allows users to see other auctions is shown. In the bottom center of the screen, the number of bids remaining in the account is shown. Additionally, a button is shown that takes the user to the main menu and another button that allows the user to access various settings is shown.

In an embodiment, each individual auction will end when the number of bids placed is sufficient to reach the reserve price (or number of bids) for that auction. There may be a display indicating the username for the most recent bidder and, optionally, a display of how many bids that user has placed in any of the individual auctions or in the auction room as a whole. There may be links to other auctions, games, information about how to use the website, or account information.

In addition, there may be a screen display that shows an individual's auction history, such as how many bids he or she used, how many auctions he or she won, and how many products he or she bought at the auction price. There may be a screen display providing an option to “BUY NOW” or “BUY-IT-NOW.” This option may allow the individual to purchase the product at retail value. Optionally, the BUY NOW price may be reduced by the number of bids used on that auction. For example, the user may have used 10 bids on an auction and lost the auction, but still may want to purchase the blender that was being auctioned. That user may apply a preset per bid value for each bid that was placed to reduce the retail value of the blender. For example, the system may allow each user to allocate $0.10 from each bid to reduce the BUY NOW price of a product. Thus, if the participant used 10 bids and received $0.10 credit for each bid, the cost of the product through the BUY NOW option would be reduced by $1.00. Alternatively, purchasing using the BUY NOW feature may cause the system to return the bids used in the auction to the bidder for use in another auction.

### Promotional Sweepstakes Module

In an embodiment of the invention, a promotional electronic sweepstakes is offered in conjunction with the auction. Sweepstakes server 120 includes this promotional electronic sweepstakes module that provides the sweepstakes functionality.

In various embodiments, before, during or after the user has completed the bidding process, system provides the user with one or more free sweepstakes entries that may be revealed by the user. In some embodiments, the number of sweepstakes entries provided to the user may correlate with the number of bids purchased. For example, a user may be awarded one sweepstakes entry for each bid purchased. In still other embodiments, the number of sweepstakes entries allocated to the user may be proportional to the number of purchased bids. For example, the user may be allocated one sweepstakes entry for every two bids purchases (e.g. a 1:2 ratio). It should be understood that the ratio of sweepstakes entries to bids purchased may be set at any level depending on the configuration of the system. Moreover, in some embodiments, the number of sweepstakes entries allocated may vary depending on the value of each bid purchased. That is, in instances where the value of each bid is higher than a standard value, the user may be allocated a greater number of sweepstakes tickets for each bid purchased. In other embodiments, the quantity of electronic sweepstakes allocated may be based on the number and/or total cost amount (e.g., in dollars or cents) of the allocated electronic bids.

In various embodiments, the sweepstakes entries may be revealed in a one-by-one fashion in conjunction with an entertaining display or may be revealed immediately and simultaneously without an entertaining display, such as by using numbers and text, for example. In other embodiments, the user receives the sweepstakes entries upon purchase of the bids, but cannot reveal the sweepstakes entries until bidding has begun. In still other embodiments, the bidding and sweepstakes reveal processes occur simultaneously. In these embodiments, one sweepstakes ticket may be revealed each time a bid is placed. In yet other embodiments, the sweepstakes reveal is completely optional and/or separated from the auction. The user may elect to bypass the sweepstakes altogether if desired. The software may provide an option upon logging in which forces the player to choose “auction only” or “auction and sweepstakes,” or some similar designation. In still other embodiments, a user may be allocated a quantity of sweepstakes entries upon the purchase of bids, but the sweepstakes tickets are not assigned to the allocated entries until the user requests that a sweepstakes entry be revealed.

In some embodiments, the sweepstakes prizes are awarded immediately upon distribution of tickets to the users. For example, if the user purchases 20 bids and received 20 sweepstakes tickets, having a total win value of $12.50, the user's account may be credited with $12.50 prior to his reveal of any individual sweepstakes ticket. Alternatively, the prize value of each ticket may only be displayed to the user upon his electronic reveal of each individual ticket.

In an embodiment, the system does not permit the bidder to purchase additional bids until he or she has used all, or a majority, of the bids in their account. For example, the system may prevent a user from buying bids unless their account contains 20 or fewer bids, 50 or fewer bids, or no bids at all.

The electronic sweepstakes itself operates in the same manner as a standard, non-electronic sweepstakes. Sweepstakes server 120 creates a finite set of sweepstakes entries and a finite set of prizes. The value of all prizes is predetermined and assigned to a specific sweepstakes entry before the sweepstakes begins. No function of the software or action by the customer can change the content of any sweepstakes entry once it, has been created and assigned a prize. The software program may randomly select the sweepstakes entries to be distributed each time a customer initiates a bid purchase or may randomly select the sweepstakes entry to be distributed each time a customer requests a reveal of a sweepstakes ticket. Alternatively, the ticket set may be created and randomized prior to any distribution to customers and the tickets may be distributed to the customers in the randomized order. The electronic sweepstakes may not require a purchase and has an alternate “no purchase necessary” method of entry which has the same odds of winning as the purchase-based entries, as they are all randomly drawn from the same ticket pool. The electronic sweepstakes may also be limited in time.

In an embodiment, at the time of purchase of bids, a central computer server in communication with sweepstakes server 120 and the end user terminal 170 randomly selects one or more sweepstakes entries for the user from a predetermined, finite pool of entries. The sweepstakes entries are then assigned to the unique account associated with that user. In another embodiment, at the time that a reveal is requested by a customer, a central computer server in communication with sweepstakes server 120 and the end user terminal 170 randomly selects one or more sweepstakes entries for the user from a predetermined, finite pool of entries. The sweepstakes entries are then assigned to the unique account associated with that user.

In another embodiment of the invention, the customer is provided with sweepstakes points at the time of the bid purchase. The points can be redeemed for sweepstakes tickets having differing point values. In this embodiment, the sweepstakes entries may be randomly selected by sweepstakes server 120 at the time of redemption for sweepstakes tickets. Thus, in these embodiments, the customer may select a particular entertaining game or a particular set of sweepstakes tickets based upon their point value, direct the system to proceed, and sweepstakes server 120 selects one or more sweepstakes tickets. In some embodiments, a sweepstakes entry and a sweepstakes ticket have the same meaning. For example, a user may be provided with either a sweepstakes entry or a sweepstakes ticket that may be revealed directly. However, in other embodiments, a sweepstakes entry may be required to redeem a sweepstakes ticket, and the sweepstakes ticket can then be revealed.

If the user elects to reveal the sweepstakes entries, the user may have the option to reveal the sweepstakes results in a text format all at once, in a one-by-one fashion, or in any other preferred fashion. Alternatively, the user may utilize an entertaining display to reveal the results of the sweepstakes tickets in a one-by-one fashion. The system may be designed such that this textual reveal may be locked by the administrator, such that the sweepstakes can only be revealed in the textual format, without the entertaining display.

In some embodiments, the entertaining display may be designed to mimic slot machine reels, a bingo game, a keno game, a poker game, a pick 'em game, a shooting game, a blackjack game, a craps game, a roulette, game, or a similar casino-style game. The games are considered “simulated games” because the games themselves have no impact on the outcome of the sweepstakes. The games may be visually pleasing or even interactive, but the entertaining aspects and/or the interaction has no impact on whether the player wins or loses. The entertainment and/or interaction merely directs the revealing of the predetermined sweepstakes ticket. Even games that appear to be skill-based are not. Multiple game options may be available to the user via the software. The sweepstakes entries received by the customer are already predetermined as winners or losers—the customer merely uses the game as an entertaining way to reveal that result.

In addition, there are various embodiments of the software that may “pre-reveal” the results of any sweepstakes ticket without any entertainment, simulation, or game. The software may present the results of the ticket in text or numeric format. In some embodiments, if the user wishes to see any visual entertainment, simulation, or game, the system will require the user to do something additional, such as press an additional button. The entertainment, simulation, or game that follows may or may not have any relationship to the sweepstakes ticket that has been revealed. In some embodiments, the ticket results are simply repeated to the user through such a simulation or game.

In various embodiments, if money is won as a prize through the sweepstakes, the software may allow the user to use that prize to purchase additional bids. In some embodiments, the sweepstakes prize may be points that can be converted to additional bids and utilized within the electronic auction. In some embodiments, the sweepstakes prize may be used to purchase products from the auction catalog. In yet other embodiments, if the user declines a product won through the bidding process, the product may be allocated to the last bidder prior to the user's winning bid.

In various embodiments, if the user wins a cash prize, the user may redeem it in a brick and mortar location through point of sale terminal 160. Alternatively, the user may be issued a prepaid credit or debit card that can be activated at the brick and mortar location or mailed to the user once the prizes have been deposited thereon. The cash prizes won in the sweepstakes may be deposited onto the prepaid credit or debit card through any means know in the art. In various other embodiments, the system may store cash prizes in the user's account until the user chooses to redeem them in cash and/or on a credit/debit card.

Similar to the electronic auction configuration, in various embodiments, the electronic sweepstakes may be stored on a local server and utilized within the walls of a brick and mortar store or on a networked server that serves a particular city, county, or state. In this scenario, sweepstakes ticket pool would be limited to the users in that brick and mortar location. Alternatively, sweepstakes server 120 could be located remotely and the ticket pool could be shared across various brick and mortar locations, states, or nationwide. Even further, sweepstakes server 120 may be a main server and available over the Internet, wherein any user that has Internet access could access the sweepstakes ticket pool. In some embodiments, the auction could be linked to other locations or across the Internet, but the sweepstakes ticket pool could be local to the brick and mortar location or vice versa.

In various embodiments, the electronic auction may run on one monitor and the sweepstakes may run simultaneously on another monitor. For example, end user terminals 170 may include dual monitors. Alternatively, the auction and sweepstakes may run simultaneously on the same monitor. In some embodiments, a user may toggle between the auction and the sweepstakes. In other embodiments, the auction and the sweepstakes are viewable on the same screen.

In various embodiments, the customer may be required to utilize all bids in the auction prior to beginning the sweepstakes reveal. In other embodiments, the customer must be actively bidding or must be the highest bidder in an auction in order to reveal a sweepstakes ticket. In other embodiments, the customer may be able to reveal all sweepstakes tickets prior to, during, or after the auction process.

In various embodiments, the user may set the system preferences for the user's account with regard to auction format, auction products, sweepstakes game skins, etc., which would be applied each time the user logs in to the system. In some embodiments, the user preferences only remain active during the current user session.

In various embodiments, the system may inquire as to whether the user would like to be notified via email or text message when items of interest (e.g., items selected by the user) will be auctioned. Upon such election, the system will monitor the particular items and when they are put on auction, the system may send the user an email or text message to notify him that an item of interest is being put up for auction.

In various embodiments, the electronic sweepstakes and auction system can be used on a mobile phone, tablet, or other mobile device. That is, a customer can (1) purchase bids over the Internet through their mobile device, (2) bid on auction items as discussed herein, and (3) reveal the sweepstakes entries, if desired, using a mobile device. It should be understood that “mobile devices are any devices that can be easily moved from location to location (e.g., tablet computers, handheld smartphones, handheld readers, iPad®, etc.). For non-smart phones, the system may provide a function that allows customers to send text messages to purchase bids, automate bidding, and provide the customer with sweepstakes results as set forth herein. In yet other embodiments, the auction and sweepstakes modules may be downloaded to a USB drive, with the appropriate security measures in place, and can be provided to a customer for home use.

The odds of any sweepstakes pool may be visually displayed within the system. This may comprise a display of the value of each prize, the number of each prize that is available, the odds for winning each prize, and/or any symbols that will be displayed according to the prize that is won.

In an embodiment, the sweepstakes simulation may comprise the peeling of a gold (or other color) layer to display symbols underneath. In this embodiment or in any embodiment, matching symbols may be an indicator that the user has won a prize. In other embodiments, the sweepstakes simulation may comprise spinning reels, doors that open and display symbols, or stamps that are opened to display a singular symbol. Any method known in the art for the display or reenactment of the prizes may be utilized.

### Exemplary Online Auction and Sweepstakes Experience

It should be understood by reference to this disclosure that these methods describe exemplary embodiments of the method steps carried out by the present system, and that other exemplary embodiments may be created by adding other steps or by removing one or more of the methods steps described herein.

In various embodiments, the system may require a user to log in to their account, optionally from end user terminal 170, by providing credentials (e.g., a user name or account number and password or other identifying credentials). In some embodiments, the user may be asked to create an account. In still further embodiments, the system may allow a user to proceed with a one-time account or to log in as a “guest.”

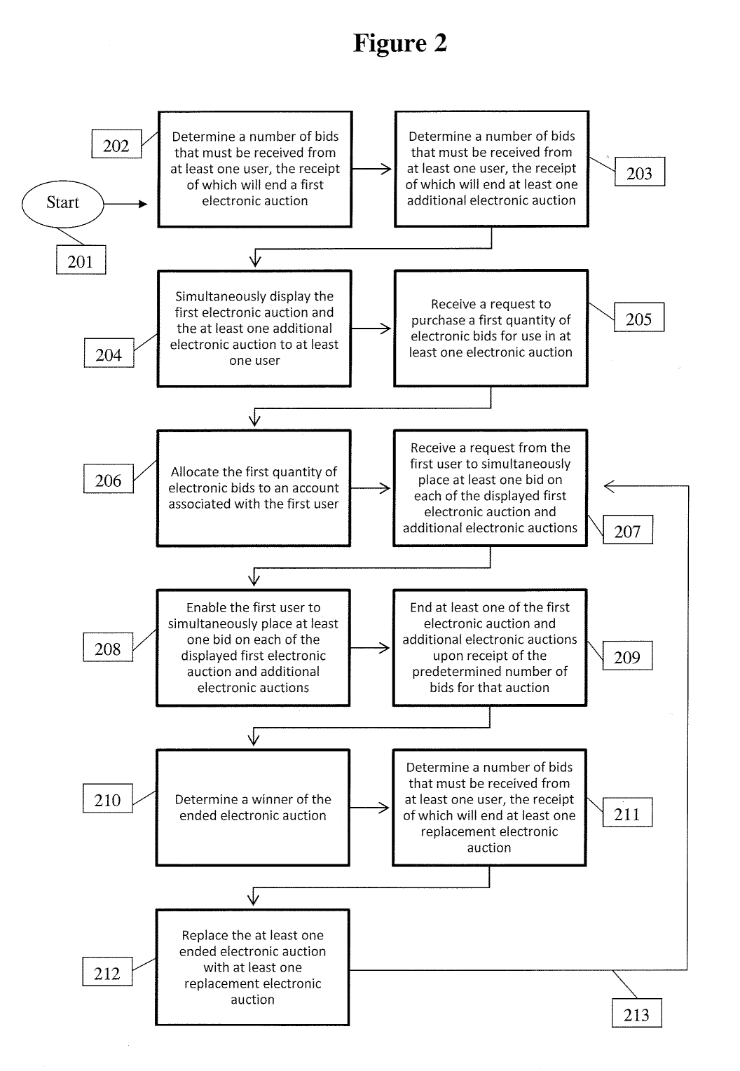

In an embodiment, shown in Step 202 of FIG. 2, the inventive system may first determine a number of bids that must be received from at least one user, the receipt of which will end a first electronic auction. In step 203, the inventive system may then determine a number of bids that must be received from at least one user, the receipt of which will end at least one additional electronic auction. This step could comprise just one additional auction, eight additional auctions, or any other number of additional auctions. The system may then simultaneously display the first electronic auction and the at least one additional electronic auction to at least one user, shown in step 204. This may be displayed in a grid format, in a circle, in a diamond format, in a triangle format, or in any known format or shape.

In step 205, the system may receive a request to purchase a first quantity of electronic bids for use in at least one electronic auction. The system may receive the request from end user terminal 170. In some embodiments, the request may be for any quantity of electronic bids. In other embodiments, the system may place restrictions on the quantity of bids a user may purchase. For example, the system may require a minimum quantity of electronic bids. Alternatively, the system may place an upper limit on the quantity of electronic bids a user may purchase. In some alternative embodiments, a user may have previously purchased bids and this step may be optional.

The system may then allocate a first quantity of electronic bids to an account associated with the first user, as shown in step 206. The system may allocate a quantity of electronic sweepstakes based on the allocated quantity of electronic bids. In various embodiments, the quantity of electronic sweepstakes entries may equal the quantity of electronic bids. In other embodiments, the quantity of electronic sweepstakes allocated may be based on the number and/or total amount (e.g., in dollars or cents) of the allocated electronic bids. In still other embodiments, the quantity of electronic sweepstakes entries may be a standard, set quantity, such as one entry per person per day, regardless of how many bids are purchased.

Shown in Step 207, the system receives a request from the first user to simultaneously place at least one bid on each of the displayed first electronic auction and additional electronic auctions. In some embodiments, the bid value allowed per bid may be predetermined. In various embodiments, the user may request to bid all or a portion of electronic bids associated with their account. The bids may be placed manually or through an automated bidding process in which the first user indicates a maximum bid they are willing to make, a maximum number of bids they are willing to place, or some other indicator, and the system will place a new bid each time the first user is outbid by another user. The automated bidding process may be set up such that a bid is placed at timed intervals, for example, a bid may be placed every five seconds.

In Step 208, the system optionally enables the first user to simultaneously place at least one bid on each of the displayed first electronic auction and additional electronic auctions. In various embodiments, the system may notify the user that the bid has been accepted. The user's username or other indicator of his identity may be displayed onscreen in an embodiment. In various embodiments, the system may display the highest or most recent bidder for the auction.

The system may display bidders and/or bids on items in a variety of ways. In some embodiments, the system may display the first bid of the first user and the bids of all other users. In other embodiments, the system may display the highest or most recent bidder only. In still further embodiments, the auction may be a “yankee auction” where none of the bidders or bids are displayed.

Shown in Step 209, the system may end at least one of the first electronic auction and additional electronic auctions upon receipt of the predetermined number of bids for that auction and, in Step 210, the system may determine a winner of the ended electronic auction. The winner may be indicated to all users or to just the winner of the auction. Any manner of notifying the winner of the action may be utilized.

The system may then replace the ended auction with another auction to be displayed in the existing grid. This may occur by the system determining a number of bids that must be received from at least one user, the receipt of which will end at least one replacement electronic auction (Step 211) and then replacing the at least one ended electronic auction with at least one replacement electronic auction (Step 212). As each auction ends, the process is repeated, as shown in Step 213. A replacement auction is created and displayed and simultaneous bidding continues. In some embodiments, the number of bids required to end a replacement auction may alternatively be determined at a different point in time, such as at the time of step 202 or 204.

In an embodiment, the system receives a request from the user to reveal a result of at least one of the first quantity of electronic sweepstakes entries. The system may allow the user to reveal sweepstakes entries at any time, only after an auction is complete, after a certain quantity or dollar value of bids are used, or any other suitable time. After receiving a request from the user to reveal a result of at least one of the first quantity of electronic sweepstakes entries, the system displays those results to the user.

Many modifications and other embodiments of the invention will come to mind to one skilled in the art to which this invention pertains having the benefit of the teachings presented in the foregoing descriptions and the associated drawings. While examples discussed above cover the use of the invention in the context a content management service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer-implemented method comprising:
a) determining, by at least one computer processor, a number of bids that must be received from at least one user, the receipt of which will end a first electronic auction;
b) determining, by at least one computer processor, a number of bids that must be received from at least one user, the receipt of which will end at least one additional electronic auction;
c) receiving, by the at least one computer processor, a request from the first user to simultaneously place at least one bid on each of the displayed first electronic auction and the at least one additional electronic auction;
d) processing, by the at least one computer processor, the request from the first user to simultaneously place at least one bid on each of the displayed first electronic auction and the at least one additional electronic auction;
e) ending, by the at least one computer processor, at least one of the first electronic auction and the at least one additional electronic auction upon receipt of the predetermined number of bids for that auction;
f) determining, by the at least one computer processor, a winner of an ended electronic auction;
g) replacing, by the at least one computer processor, the at least one ended electronic auction with at least one additional electronic auction; and
h) repeating steps (c) through (g).

2. The computer-implemented method of claim 1, wherein a first quantity of electronic sweepstakes entries are allocated to the account associated with the first user based on the first quantity of purchased electronic bids.

3. The method of claim 1 further comprising:
allocating, by the at least one processor, a first quantity of electronic sweepstakes entries to the first user account;
receiving, by the at least one computer processor, a request, from the first user, to reveal a result of at least one of the first quantity of electronic sweepstakes entries;
enabling, by at least one computer processor, the result of the at least one electronic sweepstakes entry to be revealed; and
displaying by the at least one computer processor, the result of the at least one electronic sweepstakes entry to the first user.

4. The computer-implemented method of claim 3, wherein displaying the result of the at least one electronic sweepstakes entry further comprises displaying a simulated game.

5. The computer-implemented method of claim 1, further comprising:
receiving, by the at least one computer processor, a request from the second user to simultaneously place at least one bid on each of the displayed first electronic auction and additional electronic auctions; and
processing, by the at least one computer processor, the request from the second user to simultaneously place at least one bid on each of the displayed first electronic auction and additional electronic auctions.

6. The computer-implemented method of claim 7, wherein the first user and the second user access the electronic auctions through a plurality of networked terminals.

7. The computer-implemented method of claim 1, wherein the first electronic auction and the at least one additional electronic auction are displayed simultaneously in a grid format.

8. The computer-implemented method of claim 10, wherein the grid contains nine total auctions, in a three-by-three format.

9. The computer-implemented method of claim 10, wherein the grid contains sixteen total auctions, in a four-by-four format.

10. The computer-implemented method of claim 1, wherein the first electronic auction and the at least one additional electronic auction contain items of similar retail value.

11. The computer-implemented method of claim 1, wherein the first electronic auction and the at least one additional electronic auction contain auction items having a common theme selected from the group consisting of electronics, gardening, sports, outdoors, gift cards, home, kitchen, bid packs, accessories, jewelry, appliances, luggage, vacations, and events.

12. The computer-implemented method of claim 1, wherein the first user may select the items that are included in at least one of the first electronic auction and the at least one additional electronic auction.

13. The computer-implemented method of claim 1, wherein the number of users that may participate in the first electronic auction and the at least one additional electronic auction is limited.

14. The computer-implemented method of claim 16, wherein the number of users is limited such that each auction ends in less than about 5 minutes.

15. The computer-implemented method of claim 16, wherein the number of users is limited such that each auction ends in less than about 1 minute.

16. The computer-implemented method of claim 1, wherein the number of users is limited based upon the skill level of each user.

17. The computer-implemented method of claim 1, further comprising simultaneously displaying, by the at least one computer processor on a display, the first electronic auction and the at least one additional electronic auction to at least one user.

18. The computer-implemented method of claim 1, further comprising:
a. receiving, by at the least one computer processor from a first user, a request to purchase a first quantity of electronic bids for use in at least one electronic auction; and
b. allocating, by the at least one computer processor, the first quantity of electronic bids to an account associated with the first user.

19. A system, comprising:
at least one memory storing computer-executable instructions; and
at least one processor, wherein the at least one processor is configured to access the at least one memory and to execute the computer-executable instructions to:
a) determine a number of bids that must be received from at least one user, the receipt of which will end a first electronic auction;
b) determine a number of bids that must be received from at least one user, the receipt of which will end at least one additional electronic auction;
c) receive a request from the first user to simultaneously place at least one bid on each of the displayed first electronic auction and the at least one additional electronic auction;
d) processing the request from the first user to simultaneously place at least one bid on each of the displayed first electronic auction and the at least one additional electronic auction;
e) end at least one of the first electronic auction and the at least one additional electronic auction upon receipt of the predetermined number of bids for that auction;
f) determine a winner of the ended electronic auction;
g) replace the at least one ended electronic auction with at least one additional electronic auction; and
h) repeat steps (c) through (g).

20. A system, comprising:
at least one memory storing computer-executable instructions; and
at least one processor, wherein the at least one processor is configured to access the at least one memory and to execute the computer-executable instructions to:
a) determine a number of bids that must be received from at least one user, the receipt of which will end a first electronic auction;
b) determine a number of bids that must be received from at least one user, the receipt of which will end at least one additional electronic auction;
c) receive a request from the first user to simultaneously place at least one bid on each of the displayed first electronic auction and the at least one additional electronic auction;
d) processing the request from the first user to simultaneously place at least one bid on each of the displayed first electronic auction and the at least one additional electronic auction;
e) end at least one of the first electronic auction and the at least one additional electronic auction upon receipt of the predetermined number of bids for that auction;
f) determine a winner of the ended electronic auction;
g) replace the at least one ended electronic auction with at least one additional electronic auction;
h) repeat steps (c) through (g);
i) allocate a first quantity of electronic sweepstakes tickets to the first user;
j) receive a request from the first user to reveal the content of at least one electronic sweepstakes ticket; and
k) enable the first user to reveal the content of the at least one electronic sweepstakes ticket.
